(19) United States
(12) Patent Application Publication
(10) Pub. No.: US 2026/0195203 A1
(43) Pub. Date: Jul. 9, 2026

(54) PERSONAL DATA PROTECTION METHOD

(71) Applicants: TOYOTA JIDOSHA KABUSHIKI KAISHA, Toyota-shi (JP); The University of Tokyo, Tokyo (JP)

(72) Inventors: Kenjiro TAURA, Tokyo (JP); Takumi HIRAOKA, Tokyo (JP); Shumpei SHIINA, Tokyo (JP); Sho NAKATANI, Tokyo (JP)

(73) Assignees: TOYOTA JIDOSHA KABUSHIKI KAISHA, Toyota-shi (JP); The University of Tokyo, Tokyo (JP)

(21) Appl. No.: 19/415,960

(22) Filed: Dec. 11, 2025

(30) Foreign Application Priority Data
Jan. 7, 2025 (JP) 2025-002038

(51) Int. Cl. G06F 9/54; G06F 21/62

(52) U.S. Cl. CPC G06F 9/547; G06F 21/6245

(57) ABSTRACT

A personal data protection method of the present disclosure includes sending, by a user process configured to communicate with a secure process via a remote procedure call (RPC), a first RPC request related to a first operation and a second RPC request related to a second operation to the secure process. The first operation is an operation of reading personal data or an operation of transforming the personal data. The second operation is an operation of applying differential privacy to statistical information based on the personal data. The personal data protection method further includes, by the secure process, executing the first operation based on the first RPC request, returning, to the user process, a handler corresponding to data obtained through the first operation, executing the second operation based on the second RPC request, and returning, to the user process, the statistical information to which the differential privacy has been applied.

### CROSS-REFERENCE TO RELATED APPLICATION

This application claims priority to Japanese Patent Application No. 2025-002038 filed on January 7, 2025. The disclosure of the above-identified application, including the specification, drawings, and claims, is incorporated by reference herein in its entirety.

### BACKGROUND

### 1. Technical Field

The present disclosure relates to personal data protection methods.

### 2. Description of Related Art

The system described in "Antigranular" [online], [accessed on December 25, 2024], Internet https://www.antigranular.com, accepts a data analysis program written in a general-purpose programming language and performs static program analysis. Specifically, "Antigranular" [online], [accessed on December 25, 2024], Internet https://www.antigranular.com, uses a library called RestrictedPython to restrict Python language features that cannot be guaranteed to be safe, thereby preventing unintended operations from being performed. A data analysis program that contains operations that cannot be guaranteed to be safe fails the inspection and is not executed on the server.

### SUMMARY

In the approach of "Antigranular" [online], [accessed on December 25, 2024], Internet https://www.antigranular.com, a data analysis program that has passed the inspection is executed directly on a server. However, if an unanticipated loophole exists at the inspection stage, a malicious data analysis program may pass the inspection and be executed on the server. This may result in unauthorized access to personal data. In general, general-purpose programming languages have a large attack surface, and it is difficult to statically guarantee safety. In fact, as of November 20, 2024, three vulnerabilities had been reported in the RestrictedPython library, including ones that could allow arbitrary code execution. Although the three vulnerabilities have since been patched, unknown vulnerabilities may still remain hidden. In addition, changes to the implementation of the Python language may introduce new vulnerabilities. It is not easy to keep up with changes to the language itself while ensuring safety.

The present disclosure has been made in view of the above circumstances, and an object thereof is to provide a personal data protection method that reduces the attack surface of a system that accepts programs written in a general-purpose programming language.

A personal data protection method according to the present disclosure includes sending, by a user process configured to communicate with a secure process via a remote procedure call (RPC), a first RPC request related to a first operation and a second RPC request related to a second operation to the secure process. The first operation is an operation of reading personal data or an operation of transforming the personal data, and the second operation is an operation of applying differential privacy to statistical information based on the personal data. The personal data protection method further includes, by the secure process, executing the first operation based on the first RPC request, returning, to the user process, a handler corresponding to data obtained through the first operation, executing the second operation based on the second RPC request, and returning, to the user process, the statistical information to which the differential privacy has been applied.

The present disclosure can provide a personal data protection method that reduces the attack surface of a system that accepts programs written in a general-purpose programming language.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overview of a personal data protection system according to the present disclosure; and

FIG. 2 is a diagram illustrating an example of the configuration and operation of the personal data protection system according to the present disclosure.

### DETAILED DESCRIPTION OF EMBODIMENTS

Hereinafter, specific embodiments to which the present disclosure is applied will be described with reference to the drawings. However, the present disclosure is not limited to the following embodiments. For the sake of clarity, the following description and drawings are simplified as appropriate.

### First Embodiment

The pandas library is herein used as an illustrative example. An example is described in which operations on a pandas DataFrame are written in Python. A data frame has a two-dimensional data structure composed of rows and columns. One row corresponds to the data of one individual. Each column represents an attribute of a corresponding individual (e.g., age). The operations on the data frame include a first operation and a second operation. The first operation includes an operation of reading a data frame representing personal data and an operation of transforming the data frame. The second operation includes an operation of applying differential privacy to statistical information (e.g., mean, variance, maximum, minimum) obtained through an aggregation operation on the data frame. The operation of applying differential privacy may be, for example, an operation of adding a perturbation based on the sensitivity of the operation. The perturbation may be random noise following a Laplace distribution. In the protocol definition of Remote Procedure Call (RPC), operations permitted for the data frame are enumerated, and the input/output specifications for each operation are described.

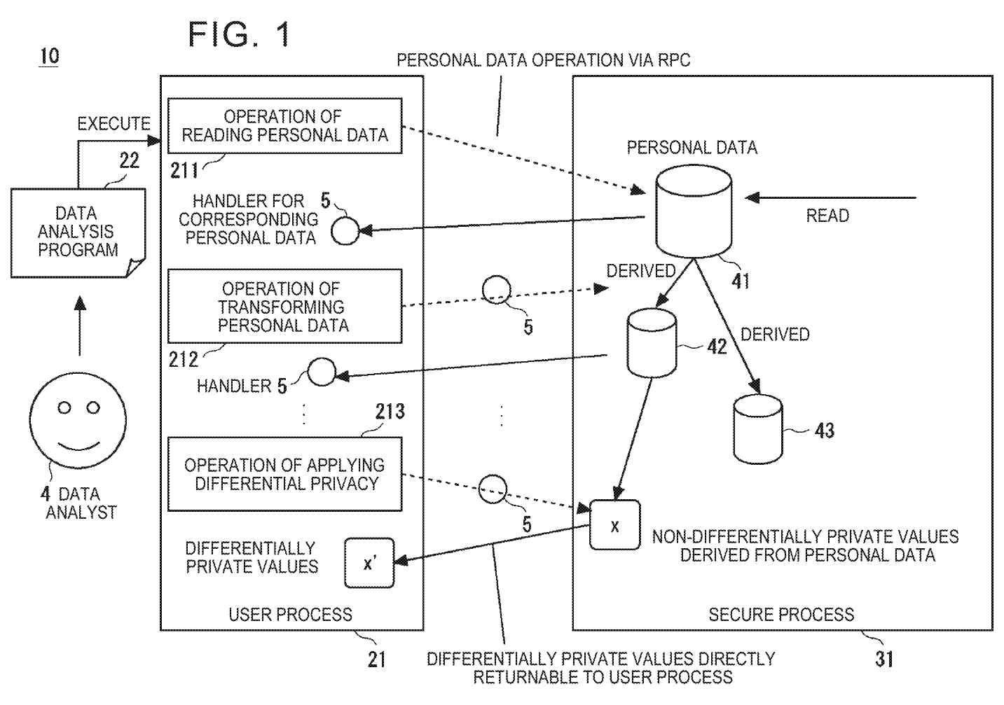

FIG. 1 is a diagram illustrating an overview of a personal data protection system 10 according to a first embodiment. The personal data protection system 10 executes a user process 21 and a secure process 31. A data analysis program 22 input by a data analyst 4 is executed within the user process 21. The user process 21 performs data operations via RPC. The data operations include an operation 211 of reading a data frame representing personal data, an operation 212 of transforming the data frame representing personal data, and an operation 213 of applying differential privacy. The operation 213 may include an aggregation operation for calculating statistical information. The user process 21 sends an RPC request corresponding to each data operation to the secure process 31.

When the secure process 31 receives an RPC request, it executes the transformation operation and aggregation operation corresponding to the RPC request. At this time, the type of response returned to the user process varies depending on the type of requested operation.

When the type of operation is an operation of reading a data frame or an operation of transforming a data frame, the secure process 31 places the output data frames of the operation (e.g., DataFrames 41, 42, 43) in memory within the secure process 31, for example, in memory on a server 30 described later. The DataFrame 41 represents the read personal data. The DataFrames 42, 43 are DataFrames derived from the DataFrame 41. The secure process 31 returns, to the user process 21, handlers 5 corresponding to the output DataFrames 41, 42 of the operation. The handlers 5 returned from the secure process 31 are used to specify the DataFrame 41 and the DataFrame 42 in RPC requests.

When the type of operation is an operation of applying differential privacy, the secure process 31 returns the output value of the operation to the user process 21 instead of a handler 5. For example, the secure process 31 calculates statistical information x from the DataFrame 42. The statistical information x is a value derived from the DataFrame 41. Differential privacy has not yet been applied to the statistical information x. Subsequently, the secure process 31 applies differential privacy to the statistical information x and returns the resulting statistical information x′, to which differential privacy has been applied, to the user process 21. The statistical information x′ is guaranteed to satisfy differential privacy.

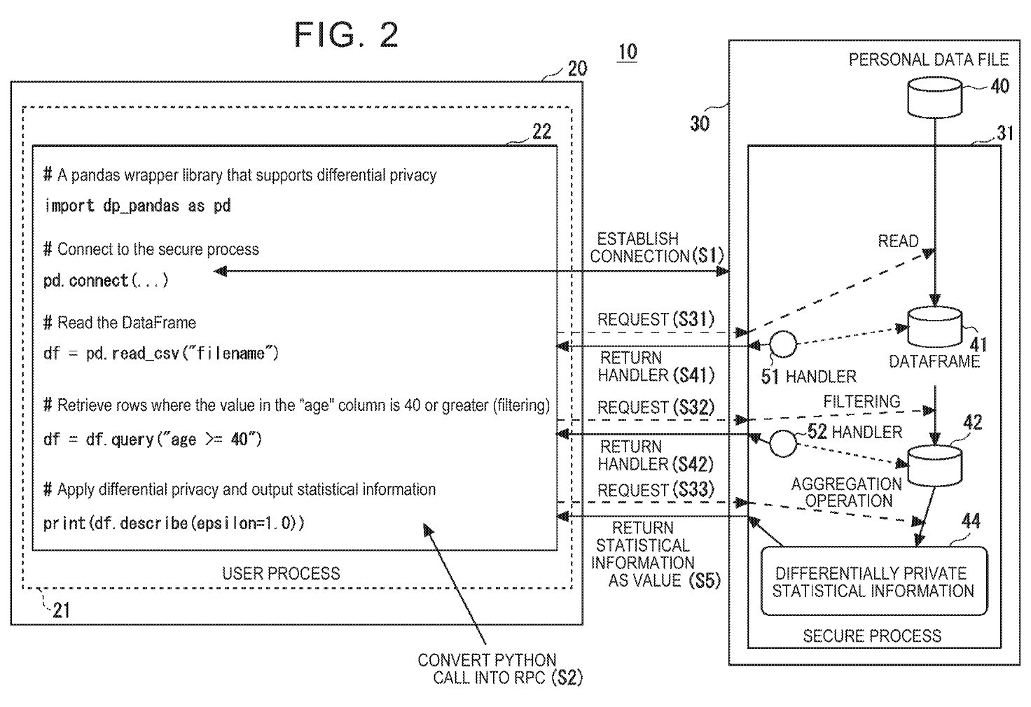

FIG. 2 is a diagram illustrating an example of the configuration and operation of the personal data protection system 10. Multiple configurations are possible for the personal data protection system 10. In the present example, however, the user process 21 is executed on a client personal computer (PC) 20, and the secure process 31 is executed on the server 30 of a personal data holder. Communication between the user process 21 and the secure process 31 is performed over a network via means such as gRPC.

The client PC 20 includes components such as a processor and memory. The client PC 20 stores the data analysis program 22 in its memory. The client PC 20 also stores, in its memory, a program (not shown) for converting methods called by the data analysis program 22 into RPC requests. By executing the program, the processor causes the client PC 20 to execute the user process 21. The server 30 also includes components such as a processor and memory. By executing a program (not shown) stored in the memory, the processor causes the server 30 to execute the secure process 31.

First, the connect() method in the data analysis program 22 is called, and the user process 21 establishes a connection to the secure process 31 (step S1).

Subsequently, when a pandas wrapper library such as the dp_pandas library is called, the user process 21 converts the library call into an RPC request and sends the RPC request to the secure process 31.

For example, the user process 21 converts a call to the read_csv() method into an RPC request (step S2), and sends the RPC request to the secure process 31 (step S31). For example, the user process 21 converts a call to the query() method, namely a method used to retrieve rows where the value in the column corresponding to the individual's age is 40 or more, into an RPC request (step S2), and sends the RPC request to the secure process 31 (step S32). For example, the user process 21 converts a call to the describe() method, namely a method related to aggregation operations, into an RPC request (step S2), and sends the RPC request to the secure process 31 (step S33). The describe() method specifies epsilon as a parameter related to differential privacy.

On the server 30 on the secure process 31 side, an RPC interface function is implemented on a processing system capable of performing operations on pandas DataFrames. The RPC interface function may generate a program based on the RPC request and execute the operation by running the program.

The secure process 31 receives the RPC request sent in step S31 and reads the DataFrame 41 from a personal data file 40. The secure process 31 receives the RPC request sent in step S32, applies filtering to the DataFrame 41, and places the resulting DataFrame 42 in memory.

The secure process 31 returns a handler 51 corresponding to the output DataFrame 41 of the operation to the user process 21 (step S41). Similarly, the secure process 31 returns a handler 52 corresponding to the output DataFrame 42 of the operation to the user process 21 (step S42). The handlers 51, 52 respectively include identifiers for the DataFrames 41, 42 within the secure process 31. The handler 51 does not include the specific values of the DataFrame 41. Similarly, the handler 52 does not include the specific values of the DataFrame 42.

The handler 51 returned from the secure process 31 is used to specify the input DataFrame 41 in the RPC request sent in step S32. The handler 52 returned from the secure process 31 is used to specify the input DataFrame 42 in the RPC request sent in step S33.

The secure process 31 receives the RPC request sent in step S33 and calculates statistical information obtained from the DataFrame 42. The secure process 31 then applies differential privacy to the calculated statistical information and returns, as a value, the resulting statistical information 44, to which differential privacy has been applied, to the user process 21 (step S5). The data analyst 4 can view the statistical information 44 using the print() method.

When the handler 51 is discarded in the user process 21, an RPC request is sent to the secure process 31, and the DataFrame 41 is also discarded in the secure process 31. When the handler 52 is discarded in the user process 21, an RPC request is sent to the secure process 31, and the DataFrame 42 is also discarded in the secure process 31.

With the above design, operations on a data frame can be written as ordinary library calls in a general-purpose programming language such as Python, without awareness of RPC. Furthermore, since operations on personal data are separated across processes, the first embodiment can reduce the attack surface of a system that accepts programs written in a general-purpose programming language, thereby lowering the risk of attacks on personal data.

In the present disclosure, part or all of the processing of the personal data protection system 10 can be implemented by causing a central processing unit (CPU) to execute a computer program.

The above-described program includes a set of instructions (or software code) that, when loaded into a computer, causes the computer to perform one or more functions described in the embodiment. The program may be stored in a non-transitory computer-readable medium or a tangible storage medium. Examples of the computer-readable medium or the tangible storage medium include, but are not limited to, random-access memory (RAM), read-only memory (ROM), flash memory, solid-state drives (SSDs), and other memory technologies; compact disc read-only memories (CD-ROMs), digital versatile discs (DVDs), Blu-ray (trademark) discs, and other optical disc storage; and magnetic cassettes, magnetic tapes, magnetic disk storage, and other magnetic storage devices. The program may be transmitted over a transitory computer-readable medium or a communication medium. Examples of the transitory computer-readable medium or the communication media include, but are not limited to, propagated signals in electrical, optical, acoustic, or other forms.

Although the present disclosure has been described with reference to the embodiments, the present disclosure is not limited thereto. Various modifications that would be understood by a person skilled in the art can be made to the configuration and details of the present disclosure without departing from the scope of the present disclosure. Each embodiment may be combined with other embodiments as appropriate.

What is claimed is:

1. A personal data protection method comprising:
sending, by a user process configured to communicate with a secure process via a remote procedure call, a first remote procedure call request related to a first operation and a second remote procedure call request related to a second operation to the secure process, the first operation being an operation of reading personal data or an operation of transforming the personal data, and the second operation being an operation of applying differential privacy to statistical information based on the personal data; and
by the secure process, executing the first operation based on the first remote procedure call request, returning, to the user process, a handler corresponding to data obtained through the first operation, executing the second operation based on the second remote procedure call request, and returning, to the user process, the statistical information to which the differential privacy has been applied.

2. The personal data protection method according to claim 1, wherein the first operation and the second operation are based on a program written in a general-purpose programming language.

3. The personal data protection method according to claim 1, wherein a data frame to be processed in the first operation and the second operation is specified using the handler.

4. The personal data protection method according to claim 1, wherein the second operation adds random noise following a Laplace distribution to the statistical information.

5. The personal data protection method according to claim 1, wherein:
the user process is executed on a client terminal; and
the secure process is executed on a server.
